(19) United States
(12) Patent Application Publication
(10) Pub. No.: US 2014/0347599 A1
(43) Pub. Date: Nov. 27, 2014

(54) BACKLIGHT MODULE AND LIQUID CRYSTAL DISPLAY DEVICE

(71) Applicant: HON HAI PRECISION INDUSTRY CO., LTD., New Taipei (TW)

(72) Inventors: TABITO HAFUKA, Tokyo (JP); ADRIAN ARTURO ACUNA MONTALVO, Tijuana (MX); JOSE DANIEL BAROCIO MONTEMAYOR, Tijuana (MX); JOSE MANUEL IBARRA VILLEZCAS, Tijuana (MX)

(73) Assignee: HON HAI PRECISION INDUSTRY CO., LTD., New Taipei (TW)

(21) Appl. No.: 13/901,611

(22) Filed: May 24, 2013

(51) Int. Cl. G02F 1/1335

(52) U.S. Cl. CPC G02F 1/1336
USPC 349/61

(57) ABSTRACT

A liquid crystal display device includes a back cover and a liquid crystal panel fixed to the back cover to form a space for receiving the backlight module. The backlight module includes a main reflecting plate, a plurality of light sources disposed on the main reflecting plate, an inverter board disposed on the main reflecting plate to simultaneously provide power for the light sources, the light sources are electrically and physically connected to the inverter board, a side reflecting sheet covering the inverter board; and a diffusion plate supported on the back cover. The main reflecting plate and the side reflecting sheet reflect light emitted by the light sources towards the diffusion plate.

### BACKGROUND

1. Technical Field

The disclosed embodiments relate to a backlight module used in a liquid crystal display device.

2. Description of Related Art

A conventional backlight module includes a main reflection sheet, a side reflection sheet, a metal back plate, an inverter board, and a light source. The main reflection sheet, the side reflection sheet, and the inverter board are disposed on the metal back plate, the light source is disposed on the main reflection sheet, the main reflection sheet and the side reflection sheet reflect light emitted by the light source toward the liquid crystal panel.

The metal back plate is used to provide the necessary strength to hold the internal separated components, such as the main reflection sheet, the side reflection sheet, the light source, and some circuit boards, etc. However, the light emitted by the light source can reach the inverter board, and the light reflecting effect of the inverter board is low, thus decreasing the reflection effect.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout three views.

FIG. 1 is an exploded view showing a liquid crystal display device in accordance with one embodiment.

FIG. 2 is a partial perspective view of the liquid crystal display device in FIG. 1.

FIG. 3 is an enlarged view of portion III in FIG. 1.

### DETAILED DESCRIPTION

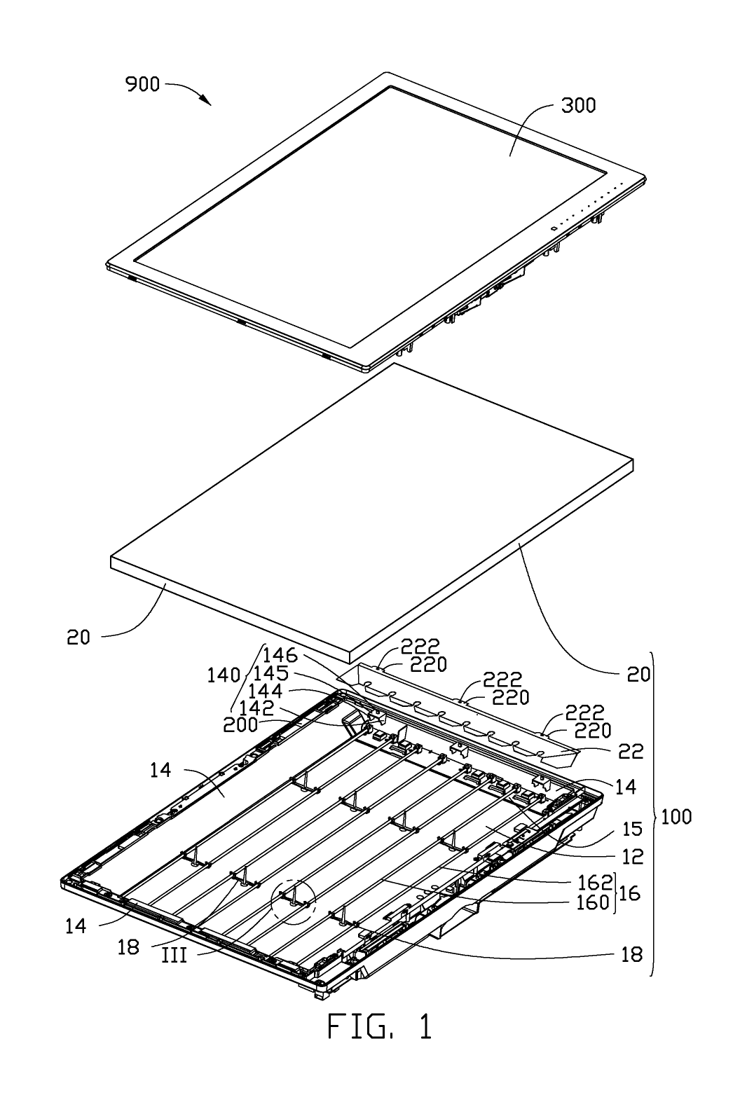

Referring to FIG. 1, a liquid crystal display device 900 includes a backlight module 100, a back cover 200, and a liquid crystal panel 300. The liquid crystal panel 300 is fixed to the back cover 200 to form a space for receiving the backlight module 100.

The backlight module 100 includes a main reflecting plate 12, four sidewall reflecting plates 14, an inverter board 15, a plurality of light sources 16, a plurality of holders 18, a diffusion plate 20, and a side reflecting sheet 22. In other embodiments, the backlight module 100 includes two or more sidewall reflecting plates 14.

The main reflecting plate 12 is rectangular. Four sidewall reflecting plates 14 respectively protrude from four rims of the main reflecting plate 12 and are interconnected with each other. The main reflecting plate 12 and four sidewall reflecting plates 14 are integrated on the back cover 200. The main reflecting plate 12, four sidewall reflecting plates 14, and the back cover 200 are made of white plastic resin. In detail, the main reflecting plate 12, four sidewall reflecting plates 14, and the back cover 200 are made of polycarbonate/acrylonitrile butadiene styrene (PC/ABS) resin and TiO2.

The inverter board 15 is fixed to one side of the main reflecting plate 12. The plurality of light sources 16 are electrically and physically connected to the inverter board 15 directly. Therefore, the inverter board 15 simultaneously provides power for the light sources 16, and the light sources 16 emit light.

In the embodiment, each light source 16 is a U-shaped lamp. Two parallel light emitting parts 160, 162 are formed on each light source 16 to directly connect to the inverter board 15. In detail, each of the two light emitting parts 160, 162 includes an electrode (not shown) electrically connected to the inverter board 15.

A plurality of holders 18 protrude from the main reflecting plate 12, support and fix the plurality of light sources 16, so that the plurality of light sources 16 are disposed above the main reflecting plate 12. The plurality of holders 18 further support the diffusion plate 20 on the back cover 200.

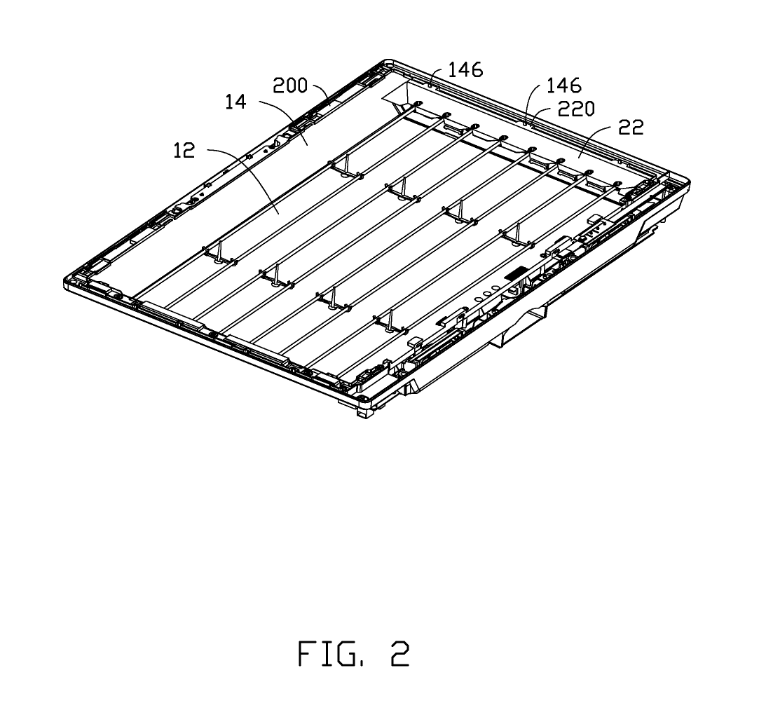

Three fixing parts 140 are formed on one of the sidewall reflecting plates 14 and are arranged in the same line. In other embodiments, more than three fixing parts 140 are formed on one of the sidewall reflecting plates 14. Referring to FIG. 2, the side reflecting sheet 22 is fixed to three fixing parts 140 and covers the inverter board 15.

In detail, each fixing part 140 includes a first side plate 142, a second side plate 144, a main plate 145, and a pin 146. The first side plate 142 and the second side plate 144 protrude from the sidewall reflecting plate 14 and are parallel to each other. The main plate 145 connects the first side plate 142 and the second side plate 144. The main plate 145 is parallel to the main reflecting plate 12. The pin 146 is formed on the main plate 145.

Three extension portions 220 protrude from the side reflecting sheet 22 and are arranged in the same line. In other embodiments, more than three extension portions 220 protrude from the side reflecting sheet 22. Each extension portion 220 defines a hole 222. Three pins 146 of the three fixing parts 140 are simultaneously fixed to three holes 222 of the three extension portions 220. Therefore, the side reflecting sheet 22 is fixed to three fixing parts 140 and covers the inverter board 15.

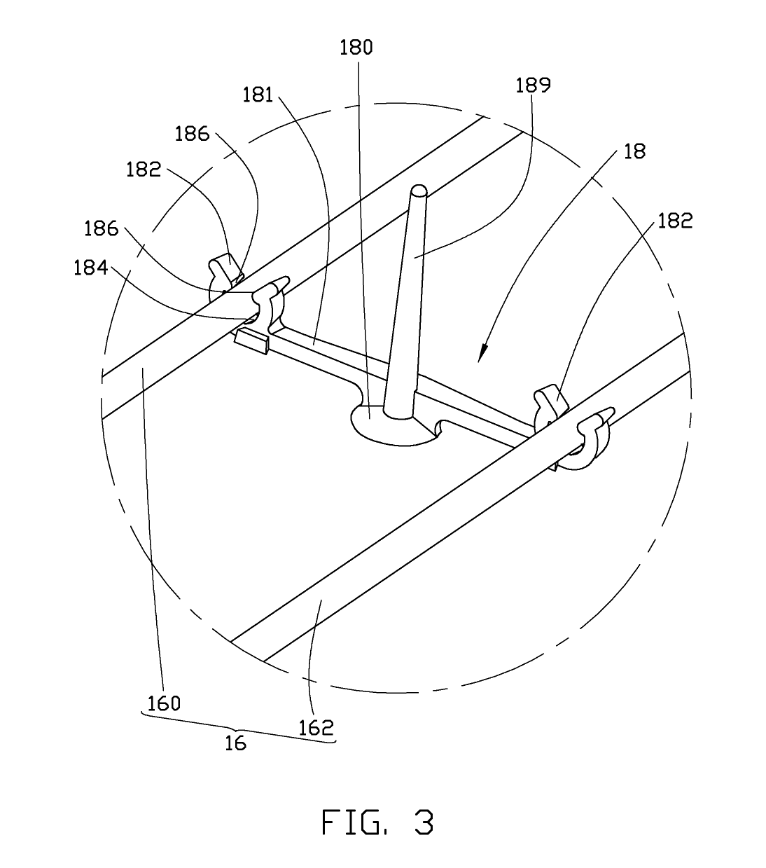

In detail, referring to FIG. 3, each holder 18 includes a base 180, a supporting arm 181, two fixing members 182, and a supporting member 189. The base 180 is fixed to the main reflecting plate 12. The supporting arm 181 and the supporting member 189 protrude from the base 180, and the supporting arm 181 intersects with the supporting member 189. In the embodiment, the supporting arm 181 is perpendicular to the supporting member 189.

Two fixing members 182 are respectively formed on two ends of the supporting arm 181. Two fixing members 182 respectively support and fix two light emitting parts 160, 162 of each lamp 16, each fixing member 182 defines a notch 184 for receiving the light emitting part 160 or 162 of the lamp 16, each fixing member 182 forms two opposite hooks 186 for abutting the light emitting part 160 or 162 of the lamp 16 to fix the light emitting part 160 or 162 of the lamp 16 in the notch 184.

The supporting member 189 supports the diffusion plate 20 on the back cover 200.

Therefore, the main reflecting plate 12, three sidewall reflecting plates 14, and the side reflecting sheet 22 reflect light emitted by the plurality of light sources 16 towards the diffusion plate 20, finally the reflected light reaches the liquid crystal panel 300, thus the liquid crystal panel 300 displays images.

In the liquid crystal display device 900, because the back cover 200, the main reflecting plate 12, four sidewall reflecting plates 14 are made of polycarbonate/acrylonitrile butadiene styrene (PC/ABS) resin and TiO2, the back cover 200 are strong enough to support the liquid crystal panel 300. Because the polycarbonate/acrylonitrile butadiene styrene (PC/ABS) resin is a white plastic resin, the main reflecting plate 12 and three sidewall reflecting plates 14 can reflect light emitted by the light sources 16 towards the diffusion plate 20.

Furthermore, the main reflecting plate 12 has a textured surface for reflecting light emitted by the light sources 16 towards the diffusion plate 20, each of the sidewall reflecting plates 14 has the textured surface for reflecting light emitted by the light sources 16 towards the diffusion plate 20. Therefore, compared to the smooth surface, the light reflecting effect of the main reflecting plate 12 and three sidewall reflecting plates 14 is enhanced. Additionally, because the sidewall reflecting plate 14 covers the inverter board 15, the light emitted by the light sources 16 is reflected by the sidewall reflecting plate 14 towards the diffusion plate 20 and can not reach the inverter board 15, and the light reflecting effect is enhanced.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. A backlight module used in a liquid crystal display device, the liquid crystal display device comprising a back cover and a liquid crystal panel fixed to the back cover to form a space for receiving the backlight module, the backlight module comprising:
a main reflecting plate;
a plurality of light sources disposed on the main reflecting plate;
an inverter board disposed on the main reflecting plate to simultaneously provide power for the light sources, the light sources electrically and physically connected to the inverter board;
a side reflecting sheet covering the inverter board; and
a diffusion plate supported on the back cover;
wherein the main reflecting plate and the side reflecting sheet reflect light emitted by the light sources towards the diffusion plate.

2. The backlight module of claim 1, further comprising a plurality of sidewall reflecting plates protruding from rims of the main reflecting plate, wherein the main reflecting plate is integrated on the back cover, the sidewall reflecting plates are interconnected with each other, the sidewall reflecting plates are integrated on the back cover and reflect light emitted by the light sources towards the diffusion plate.

3. The backlight module of claim 2, wherein the main reflecting plate has a textured surface for reflecting light emitted by the light sources, each sidewall reflecting plate has the textured surface for reflecting light emitted by the light sources, the side reflecting sheet has the textured surface for reflecting light emitted by the light sources.

4. The backlight module of claim 2, wherein a plurality of fixing parts are formed on one of the sidewall reflecting plates, the side reflecting sheet is fixed to the fixing parts.

5. The backlight module of claim 4, wherein each fixing part comprises a first side plate, a second side plate, a main plate, and a pin; the first side plate and the second side plate protrude from the sidewall reflecting plate, the main plate connects the first side plate and the second side plate, the pin is formed on the main plate; and a plurality of extension portions protrude from the side reflecting sheet, each extension portion defines a hole, the pins of the plurality of fixing parts are simultaneously fixed to the holes of the plurality of extension portions.

6. The backlight module of claim 1, further comprising a plurality of holders protruding from the main reflecting plate, supporting and fixing the light sources; wherein the holders further support the diffusion plate on the back cover.

7. The backlight module of claim 6, wherein each holder comprises a base, a supporting arm, two fixing members, and a supporting member; the base is fixed to the main reflecting plate, the supporting arm and the supporting member protrude from the base, the supporting arm intersects with the supporting member; two fixing members are respectively formed on two ends of the supporting arm, each fixing member supports and fixes the light source, the supporting member supports the diffusion plate on the back cover.

8. The backlight module of claim 7, wherein each light source is a lamp, the lamp is U-shaped lamp which form two light emitting parts to directly and electrically connect to the inverter board; two fixing members respectively support and fix two light emitting parts of each lamp.

9. The backlight module of claim 8, wherein each fixing member defines a notch for receiving the light emitting part of the lamp, each fixing member forms two opposite hooks for abutting the light emitting part of the lamp to fix the light emitting part of the lamp in the notch.

10. A liquid crystal display device, comprising:
a back cover;
a backlight module; and
a liquid crystal panel fixed to the back cover to form a space for receiving the backlight module;
wherein the backlight module comprises:
a main reflecting plate;
a plurality of light sources disposed on the main reflecting plate;
an inverter board disposed on the main reflecting plate to simultaneously provide power for the light sources, the light sources electrically and physically connected to the inverter board;
a side reflecting sheet covering the inverter board; and
a diffusion plate supported on the back cover;
wherein the main reflecting plate and the side reflecting sheet reflect light emitted by the light sources towards the diffusion plate.

11. The liquid crystal display device of claim 10, wherein the backlight module further comprises a plurality of sidewall reflecting plates protruding from rims of the main reflecting plate, the main reflecting plate is integrated on the back cover, the sidewall reflecting plates are interconnected with each other, the sidewall reflecting plates are integrated on the back cover and reflect light emitted by the light sources towards the diffusion plate.

12. The liquid crystal display device of claim 11, wherein the main reflecting plate has a textured surface for reflecting light emitted by the light sources, each sidewall reflecting plate has the textured surface for reflecting light emitted by the light sources, the side reflecting sheet has the textured surface for reflecting light emitted by the light sources.

13. The liquid crystal display device of claim 11, wherein a plurality of fixing parts are formed on one of the sidewall reflecting plates, the side reflecting sheet is fixed to the fixing parts.

14. The liquid crystal display device of claim 13, wherein each fixing part comprises a first side plate, a second side plate, a main plate, and a pin; the first side plate and the second side plate protrude from the sidewall reflecting plate, the main plate connects the first side plate and the second side plate, the pin is formed on the main plate; a plurality of extension portions protrude from the side reflecting sheet, each extension portion defines a hole, the pins of the plurality of fixing parts are simultaneously fixed to the holes of the plurality of extension portions.

15. The liquid crystal display device of claim 10, where the backlight module further comprises a plurality of holders protruding from the main reflecting plate, supporting and fixing the light sources; the holders further support the diffusion plate on the back cover.

16. The liquid crystal display device of claim 15, wherein each holder comprises a base, a supporting arm, two fixing members, and a supporting member; the base is fixed to the main reflecting plate, the supporting arm and the supporting member protrude from the base, the supporting arm intersects with the supporting member; two fixing members are respectively formed on two ends of the supporting arm, each fixing member supports and fixes the light source, the supporting member supports the diffusion plate on the back cover.

17. The liquid crystal display device of claim 16, wherein each light source is a lamp, the lamp is U-shaped lamp which form two light emitting parts to directly and electrically connect to the inverter board; two fixing members respectively support and fix two light emitting parts of each lamp.

18. A backlight module used in a liquid crystal display device, the liquid crystal display device comprising a back cover and a liquid crystal panel fixed to the back cover to form a space for receiving the backlight module; the backlight module comprising:
a main reflecting plate;
a plurality of light sources disposed on the main reflecting plate; and
a diffusion plate supported on the back cover;
wherein the main reflecting plate has a textured surface for reflecting light emitted by the light sources towards the diffusion plate.

19. The backlight module of claim 18, further comprising a plurality of sidewall reflecting plates protruding from rims of the main reflecting plate, wherein the main reflecting plate is integrated on the back cover, the sidewall reflecting plates are interconnected with each other, the sidewall reflecting plates are integrated on the back cover and have the textured surface for reflecting light emitted by the light sources towards the diffusion plate.

20. The backlight module of claim 18, wherein the back cover and the main reflecting plate are made of polycarbonate/acrylonitrile butadiene styrene (PC/ABS) resin and TiO2.
